(19) United States
(12) Patent Application Publication
(10) Pub. No.: US 2013/0301423 A1
(43) Pub. Date: Nov. 14, 2013

(54) METHOD, SYSTEM AND APPARATUS OF TIME-DIVISION-DUPLEX (TDD) UPLINK-DOWNLINK (UL-DL) INTERFERENCE MANAGEMENT

(71) Applicants: Alexander Sirotkin, Giv'on Hachadasha (IL); Alexey Khoryaev, Dzerzhinsk (RU); Andrey Chervyakov, Nizhny Novgorod (RU); Mikhail A. Shilov, Nizhny Novgorod (RU); Sergey Panteleev, Nizhny Novgorod (RU)

(72) Inventors: Alexander Sirotkin, Giv'on Hachadasha (IL); Alexey Khoryaev, Dzerzhinsk (RU); Andrey Chervyakov, Nizhny Novgorod (RU); Mikhail A. Shilov, Nizhny Novgorod (RU); Sergey Panteleev, Nizhny Novgorod (RU)

(21) Appl. No.: 13/890,403

(22) Filed: May 9, 2013

Related U.S. Application Data
(60) Provisional application No. 61/646,223, filed on May 11, 2012.

(51) Int. Cl. H04J 3/16

(52) U.S. Cl. CPC H04J 3/1694
USPC 370/241.1; 370/280; 370/252; 370/329

(57) ABSTRACT

Some demonstrative embodiments include devices, systems and/or methods of Time-Division Duplexing (TDD) Uplink-Downlink (UL-DL) interference management. Some embodiments include transmitting a message including a channel quality parameter and a Time-Division-Duplex (TDD) configuration update to at least one other base station of a cellular cell, deciding if the cellular cell is to be operated in a cluster based on the channel quality parameter value, and coordinating an adjustment of uplink-downlink configuration according to a traffic condition.

### CROSS REFERENCE

This application claims the benefit of and priority from U.S. Provisional Patent Application No. 61/646,223 entitled “Advanced Wireless Communication Systems and Techniques”, filed May 11, 2012, the entire disclosure of which is incorporated herein by reference.

### TECHNICAL FIELD

Embodiments described herein generally relate to interference management in a communication network.

### BACKGROUND

Traffic communicated in a communication network, e.g., a cellular network, may often be asymmetrical in time or cell domains. For instance, the amount of Downlink (DL) and Uplink (UL) traffic may be significantly different and may vary in time and/or across different cells. Such traffic variation may be handled effectively, for example, by adapting the amount of time resources assigned to the DL and the UL, e.g. using different Time Division Duplexing (TDD) frame configurations.

TDD offers flexible deployments without requiring a pair of spectrum resources. For TDD deployments in general, interference between UL and DL including both Base Station (BS) to BS and User Equipment (UE) to UE interference needs to be considered. One example includes layered heterogeneous network deployments, where it may be of interest to consider different uplink-downlink configurations in different cells. Also of interest are deployments involving different carriers deployed by different operators in the same band and employing either the same or different uplink-downlink configurations, where possible interference may include adjacent channel interference as well as co-channel interference such as remote BS-to-BS interference.

Long-Term-Evolution (LTE) TDD allows for asymmetric UL-DL allocations by providing a semi-static allocation utilizing seven different semi-statically configured uplink-downlink configurations. The semi-static allocation may or may not match the actual instantaneous traffic situation. TDD systems may handle traffic variation by adapting the amount of time resources assigned to DL and UL, e.g. use different TDD frame configurations.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a cellular system, in accordance with some demonstrative embodiments.

FIG. 2 is a schematic flow chart illustration of a method of cluster management in accordance with some demonstrative embodiments.

FIG. 3 is a schematic illustration of a base station, in accordance with some demonstrative embodiments.

FIG. 4 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Some embodiments may be used in conjunction with devices and/or networks operating in accordance with existing Long Term Evolution (LTE) specifications, e.g., 3GPP TS 36.423: Evolved Universal Terrestrial Radio Access Network (E-UTRAN); X2 Application Protocol (X2AP) (“RAN 3”), 3GPP TS 36.201: “Evolved Universal Terrestrial Radio Access (E-UTRA); Physical Layer—General Description” (“RAN 1”), and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee™, Ultra-Wideband (UWB), Global System for Mobile communication (GSM), second generation (2G), 2.5G, 3G, 3.5G, 4G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1XRTT), Evolution-Data Optimized (EV-DO), Enhanced Data rates for GSM Evolution (EDGE), and the like. Other embodiments may be used in various other devices, systems and/or networks.

The phrase “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the phrase “wireless device” may optionally include a wireless service.

The term “User Equipment (UE)”, as used herein with respect to LTE and any other wireless communication systems, may include any equipment, which allows a user access to network services. An interface between the UE and the network is the radio interface. A User Equipment may be subdivided into a number of domains which may be separated by reference points, if desired.

The term “Downlink (DL)”, as used herein with respect to LTE and any other wireless communication systems, may include an unidirectional radio link for the transmission of signals from an access point and/or a base station to a UE. The term DL may also refer in general the direction from the Network to the UE.

The term “Uplink (UL)”, as used herein with respect to LTE and any other wireless communication systems, may include a unidirectional radio link for the transmission of signals from a UE to a base station, from a Mobile Station to a mobile base station or from a mobile base station to a base station. The term UL may also refer in general the direction from the UE to the Network.

The term “Base Station (BS)”, as used herein with respect to LTE and any other wireless communication systems, may include a network element in radio access network responsible for radio transmission and reception in one or more cells to or from the user equipment. A base station may have an integrated antenna or be connected to an antenna by feeder cables, if desired. According to embodiments of the invention, equivalent terms to BS may be used, for example eNB, eNodeB, eNode B or the like.

The term “Pico cells”, as used herein with respect to LTE and any other wireless communication systems, may include cells, e.g., mainly indoor cells, with a radius that may be, for example, less than 50 meters.

The term “X2”, as used herein with respect to LTE cellular system, may include a logical interface between at least two eNBs. Whilst logically representing a point to point link between eNBs, the physical realization need not be a point to point link.

The term “communicating”, as used herein with respect to a wireless communication signal, may include transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a WiMax cellular network, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The term “cell”, as used herein, may include a Radio network object that may be uniquely identified by a User Equipment, for example, from a (cell) identification that is broadcasted over a geographical area from one Access Point. A Cell, as used herein, may operate, for example, in either a Frequency Division Duplex (FDD) mode or a Time Division Duplex (TDD) mode. Furthermore, the cell may include a combination of network resources, for example, downlink and optionally uplink resources. The resources may be controlled and/or allocated, for example, by a cellular node (“also referred to as a “base station”), or the like. The linking between a carrier frequency of the downlink resources and a carrier frequency of the uplink resources may be indicated in system information transmitted on the downlink resources.

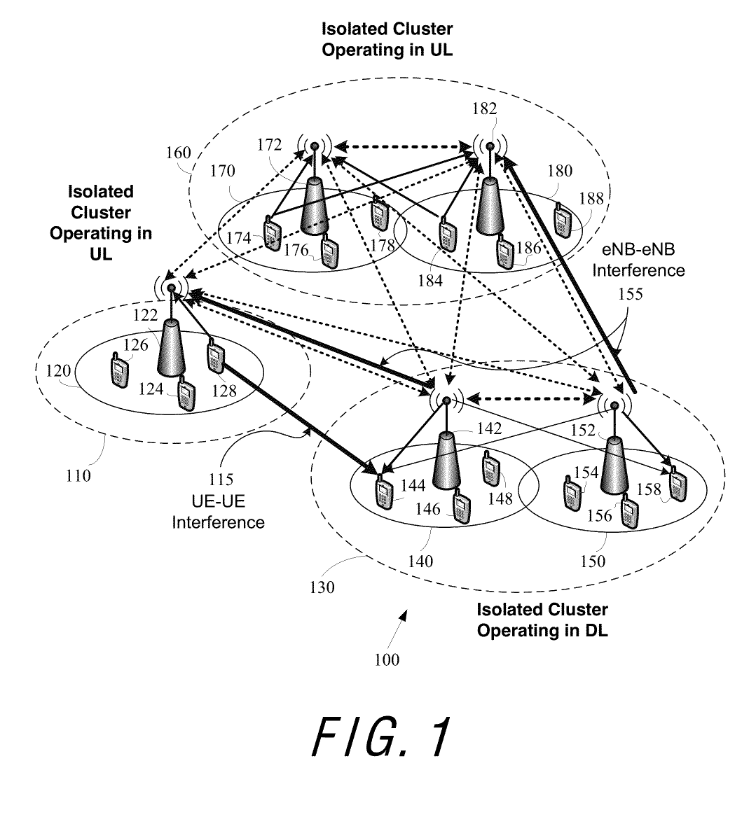

Reference is now made to FIG. 1, which schematically illustrates a block diagram of a cellular system 100, in accordance with some demonstrative embodiments. For example, cellular system 100 may include a 4^{th} generation cellular system such as, for example, a WiMAX cellular system, a long term evolution (LTE) or LTE advance cellular system, and the like.

Although some embodiments are not limited to this example of cellular system 100, the cellular system 100 may include a plurality of cellular cells, e.g., including cells 120, 140, 150, 170 and/or 180. According this example embodiment, a cell, e.g., cell 120, 140, 150, 170 and/or 180, may include at least one base station, for example, base station 122, 142, 152, 172 and/or 182 and a plurality of wireless communication devices. For example, cell 120 may include BS 122 and wireless communication devices 124, 126 and 128. Cell 140 may include BS 142 and wireless communication devices 144, 146 and 148. Cell 150 may include BS 152 and wireless communication devices 154, 156 and 158. Cell 170 may include BS 172 and wireless communication devices 174, 176 and 178.

According to some demonstrative embodiments, in order to provide interference mitigation (IM), the cells may be grouped into clusters. For example, a cluster 110 may include cell 120, a cluster 130 may include cells 140 and 150, and/or a cluster 160 may include cells 170 and 180. Furthermore, cluster 110 may operate in UL, cluster 130 may operate in DL and cluster 160 may also operate in UL, although it should be understood that some embodiments are not limited to this example.

According to one demonstrative embodiment, cellular system 100 may include an LTE cellular system. Base stations 122, 142, 152, 172 and 182 may include a cellular node such as, for example, a NodeB, an eNodeB a HeNobeB or the like. Wireless communication devices may include, but not limited to, a UE. In some demonstrative embodiments, UEs 124, 126, 128, 144, 146, 148, 154, 156, 158, 174, 176, 178, 184, 186 and/or 188 may include, for example, a mobile computer, a laptop computer, a notebook computer, a tablet computer, a mobile internet device, a handheld computer, a handheld device, a storage device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a video device, an audio device, an A/V device, a gaming device, a media player, a Smartphone, or the like.

In some demonstrative embodiments, the pluralities of UEs may communicate with the BS within each cell and the base stations may communicate with each other, if desired. The communications may cause interference. For example, an eNB-to-eNB interference 155 and/or a UE-UE interference 115.

In some demonstrative embodiments, an interference mitigation (IM) scheme may be provided, for example, in order to mitigate the above-mentioned interferences. For example, in LTE cellular systems the IM scheme may be named Cell Clustering IM (CCIM), which may divide the cells into two or more cell clusters according to some metric(s), such as, for example coupling loss, interference level, and the like, between cells, although some embodiments are not limited to this example.

In some demonstrative embodiments, a cell cluster, for example, isolated cluster 130 may include one or more cells. The active transmissions of all cells in a cell, e.g., each cell, cluster may be, for example, either UL or DL in any subframe or a subset of all subframes, for example, such that eNB-to-eNB interference 155 and UE-to-UE interference 115 may be mitigated within the cell cluster. Transmission directions in cells belonging to different cell clusters may be different in a subframe, for example, by selecting the different TDD configurations in an unconditioned manner, e.g., in order to achieve the benefits of TDD UL-DL reconfiguration based on traffic adaptation. eNB-to-eNB and UE-to-UE interference between cells in different cell clusters may be controlled, for example, by forming the cell clusters.

In some demonstrative embodiments, CCIM may include at least two functionalities, for example, forming cell clusters and coordinating the transmission within each cell cluster. To properly form the cell clusters, eNB measurements may need to be possible, for example, where the purpose of the eNB measurements is to estimate the interference level from/to another eNB.

In some demonstrative embodiments, signaling and/or procedures related to the eNB measurements may be supported for coordination within the isolated cluster, e.g., isolated cluster 130, if desired.

In some demonstrative embodiments, there may be at least two different types of DL-UL interference that may be handled to optimize system performance. For example, a first DL-UL interference may be adjacent channel interference and/or a second DL-UL interference may be co-channel interference. The adjacent channel interference may be injected due to non-ideality (non-linearity) of RF chains and may include for example adjacent channel leakage ratio (ACLR), adjacent channel selectivity (ACS) and propagation loss of the channel. For the case of the co-channel interference the base stations may perform any type of measurements including, for example, channel, path gain and/or DL-UL interference level measurements, and the like. In case of adjacent channel interference, the overall attenuation of interference signal may be measured.

Some demonstrative embodiments may benefit from the advantages of TDD networks over FDD systems. One of the significant benefits of TDD systems is their potential flexibility to react when changing of traffic conditions may be required.

In some demonstrative embodiments, cellular cells 120, 140, 150, 170 and/or 180 may utilize the TDD UL-DL configuration information, for example, for enhanced Interference Management and Traffic Adaptation (eIMTA), and/or for any other purpose. Cellular cells 120, 140, 150, 170 and/or 180 may utilize the TDD UL-DL configuration information, for example, for dynamic TDD UL-DL configuration, if desired.

In some demonstrative embodiments, in order to form an isolated cluster, for example, isolated cluster 110, isolated cluster 130 and/or isolated cluster 160, the eNB, e.g., BS 142, may transmit, for example, via an X2 application protocol (X2AP), a message including a channel quality parameter and a TDD configuration update, for example, to inform at least one other cell. The channel quality parameter may be used, for example, to decide which one or more communication devices is to be included in an one or more isolated clusters, if desired.

According to some exemplary embodiments of the invention the message may be a part of X2AP, designed for dynamic TDD UL-DL configuration adaptation. This message may be named an X2 message, although it should be understood that the scope of this embodiment is not limited to X2 messages.

In some demonstrative embodiments, X2 and Operations, Administration, and Maintenance (OAM) functionalities may be able to support eIMTA. The X2 messages may be used to assist, for example, eNBs in interference mitigation, if desired. Parameters that may assist the eNBs in interference mitigation may be, for example, exchanged via X2 interface, e.g., to implement a distributed coordination scheme, or made available for OAM, e.g., to implement a centralized coordination scheme.

In some demonstrative embodiments, an X2AP message, e.g., an Inter-cell path gain message, may be used. Using this message, for example, an eNB may signal to its peer eNBs path gain (path loss) of inter-cell BS-BS links. For example, this information jointly with the eNB transmit power may be used to analyze the level of DL-UL interference from neighboring cells, e.g., how DL interference affects the UL reception. In addition, this DL-UL interference level may be applied to make a decision whether the peer eNBs may be considered as an isolated cell, e.g. cell 120 or may form an isolated cluster, e.g. isolated cluster 160, and work synchronously, jointly coordinating adjustment of UL-DL configurations to traffic conditions, if desired.

A LOAD INFORMATION X2AP message is to transfer load and/or interference coordination information between eNBs controlling intra-frequency neighboring cells. The below LOAD INFORMATION message as illustrated in table 1, may be sent by an eNB to neighboring eNBs to transfer load and interference coordination information.

TABLE 1
Inter-cell path gain message
Direction: eNB₁ → eNB₂.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| Cell Information | M | | | | YES | ignore |
| >Cell Information | | 1 . . . <maxCellineNB> | | | EACH | ignore |
| Item | | | | | | |
| >>Cell ID | M | | ECGI | Id of the | — | — |
| | | | 9.2.14 | source cell | | |
| >>UL Interference | O | | 9.2.17 | | — | — |
| Overload | | | | | | |
| Indication | | | | | | |
| >>UL High | | 0 . . . <maxCellineNB> | | | — | — |
| Interference | | | | | | |
| Information | | | | | | |
| >>>Target Cell ID | M | | ECGI | Id of the | — | — |
| | | | 9.2.14 | cell for | | |
| | | | | which the | | |
| | | | | HII is meant | | |
| >>>UL High | M | | 9.2.18 | | — | — |
| Interference | | | | | | |
| Indication | | | | | | |
| >>Relative | O | | 9.2.19 | | — | — |
| Narrowband Tx | | | | | | |
| Power (RNTP) | | | | | | |
| >>ABS | O | | 9.2.54 | | YES | ignore |
| Information | | | | | | |
| >>Invoke | O | | 9.2.55 | | YES | Ignore |
| Indication | | | | | | |
| >>Path Gain | O | | | | YES | ignore |
| Indication | | | | | | |

In one demonstrative embodiment of the invention, a Path Gain Indication information element (IE) indicating the path gain in dB between two cells is disclosed. A value of the path gain indication IE may be defined either as integer or enumerated value. Alternatively, in another embodiment of the invention, the path gain information between two cells is made available for OAM, although other embodiments are not limited to these embodiments.

According to a second exemplary embodiment of the invention, an X2AP message, e.g., an Average interference over thermal noise (IoT) in UL, is disclosed in Table 2. By using this message an eNB e.g., BS 122, may signal to its peer eNBs e.g., BS 172, or BS 142 an average level of UL inter-cell interference in a particular cell.

TABLE 2
Average IoT message
Direction: eNB₁ → eNB₂.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| Cell Information | M | | | | YES | ignore |
| >Cell | | 1 . . . <maxCellineNB> | | | EACH | ignore |
| Information | | | | | | |
| Item | | | | | | |
| >>Cell ID | M | | ECGI | Id of the | — | — |
| | | | 9.2.14 | source cell | | |
| >>UL | O | | 9.2.17 | | — | — |
| Interference | | | | | | |
| Overload | | | | | | |
| Indication | | | | | | |
| >>UL High | | 0 . . . <maxCellineNB> | | | — | — |
| Interference | | | | | | |
| Information | | | | | | |
| >>>Target Cell | M | | ECGI | Id of the | — | — |
| ID | | | 9.2.14 | cell for | | |
| | | | | which the | | |
| | | | | HII is meant | | |
| >>>UL High | M | | 9.2.18 | | — | — |
| Interference | | | | | | |
| Indication | | | | | | |
| >>Relative | O | | 9.2.19 | | — | — |
| Narrowband Tx | | | | | | |
| Power (RNTP) | | | | | | |
| >>ABS | O | | 9.2.54 | | YES | ignore |
| Information | | | | | | |
| >>Invoke | O | | 9.2.55 | | YES | Ignore |
| Indication | | | | | | |
| >>IoT | | | | | | |
| Indication | | | | | | |
| >>IoT | | | | | | |
| Information | | | | | | |
| >>>Target Cell | | | | | | |
| ID | | | | | | |
| >>>IoT | | | | | | |
| Indication | | | | | | |

According to this exemplary embodiment of the invention, the IoT IE may indicate an average level of UL inter-cell interference in a particular cell. As shown in Table 2, at least two possible implementations may be defined. A first possible implementation may use the IoT Indication IE. A second possible implementation may use the IoT Information IE field which includes Target Cell ID and IoT Indication subfields. One difference between the two implementations may be the presence of the Target Cell ID IE, which indicates the ID of the cell for which the IoT is meant. In another embodiment, the IoT information between two cells may be made available for OAM, although other embodiments are not limited to this embodiment.

According to a third exemplary embodiment of the invention, an X2AP message, e.g., a DL Transmit Power Control Map is disclosed with Table 3 below. By using this message an eNB, e.g., BS 122, may signal to its peer eNBs, e.g., BS 142, the DL transmit power levels which are used in flexible subframes, e.g., subframes that may dynamically change their transmission direction from DL to UL and vice versa in the process of UL-DL frame configuration change, for example, subframes #3, 4, 7, 8, 9).

In some demonstrative embodiments, this message may also include the power level that is used at the regular subframes, e.g., all the remaining subframes which do not change the transmission direction in the process of UL-DL frame configuration change. This message may be used, for example, when DL power control approach is adopted to avoid DL-UL interference problem.

TABLE 3
DL Transmit Power Control Map message
Direction: eNB₁ → eNB₂.

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | ignore |
| Cell Information | M | | | | YES | ignore |
| >Cell | | 1 . . . <maxCellineNB> | | | EACH | ignore |
| Information | | | | | | |
| Item | | | | | | |
| >>Cell ID | M | | ECGI | Id of the | — | — |
| | | | 9.2.14 | source cell | | |
| >>UL | O | | 9.2.17 | | — | — |
| Interference | | | | | | |
| Overload | | | | | | |
| Indication | | | | | | |
| >>UL High | | 0 . . . <maxCellineNB> | | | — | — |
| Interference | | | | | | |
| Information | | | | | | |
| >>>Target Cell | M | | ECGI | Id of the | — | — |
| ID | | | 9.2.14 | cell for | | |
| | | | | which the | | |
| | | | | HII is meant | | |
| >>>UL High | M | | 9.2.18 | | — | — |
| Interference | | | | | | |
| Indication | | | | | | |
| >>Relative | O | | 9.2.19 | | — | — |
| Narrowband Tx | | | | | | |
| Power (RNTP) | | | | | | |
| >>ABS | O | | 9.2.54 | | YES | ignore |
| Information | | | | | | |
| >>Invoke | O | | 9.2.55 | | YES | Ignore |
| Indication | | | | | | |
| >>DL Tx Power | | 0 . . . 9 | | | | |
| Information | | | | | | |
| >>>Subframe | | | | | | |
| Index | | | | | | |
| >>>Tx Power | | | | | | |

According to this embodiment, the DL Tx Power IE may include a list of, e.g., up to 10 entries for a subframe, e.g., each subframe, which indicates a subframe index and TX power value for this subframe. The TX Power IE value may be defined either as integer or as an enumerated type. Alternatively, this information can be configured by OAM, although some embodiments not limited in this respect.

According to a forth exemplary embodiment of the invention, a DL-UL interference management method is disclosed. According to these embodiments, the TDD Cluster Management procedure may be used to avoid the negative impact of the DL-UL interference on the UL SINR performance.

Although some embodiments are not limited to this example, according to the DL-UL interference management method selected deployed Pico cells may be divided into isolated clusters, e.g., isolated clusters 110, 130 and 160. The created clusters may be isolated from each other, for example, in terms of harmful eNB-to-eNB interference and may contain either one isolated Pico cell, for example, isolated cluster 110 and/or a group of Pico cells, which, for example, may be characterized by a significant coupling on Pico-Pico links, for example, isolated clusters 130 and 160.

According to this example, in order to divide the Pico cells into clusters the path gain of Pico-Pico links may be compared with the certain threshold, for example −90 dB, to decide whether particular Pico stations may be combined into a cluster. However, the threshold may be adjusted, e.g., to keep the DL-UL interference in a desired level, for example, at an UL inter cell interference level.

According to one demonstrative embodiment, the Pico cells may be assigned to clusters in a centralized way by an OAM. The OAM may collect path gain measurements from the eNBs for the cells supported by these eNBs, compare them to the above threshold and assign each cell to an appropriate cluster. For example, the path gain values and/or other indicators may be used to make a decision. New UL-DL configurations may be reported using OAM. Thus, for example, only the centralized node may know which eNB belongs to which cluster, although some embodiments are not limited to this example.

In another demonstrative embodiment, the clusters may be formed in a distributed fashion, e.g., by eNBs via X2. The eNBs may exchange path gain measurements for each cell managed by these eNBs via X2AP message defined above, compare them with a threshold (preconfigured via OAM) and, if the measurement is below the threshold value, the cells may form a cluster.

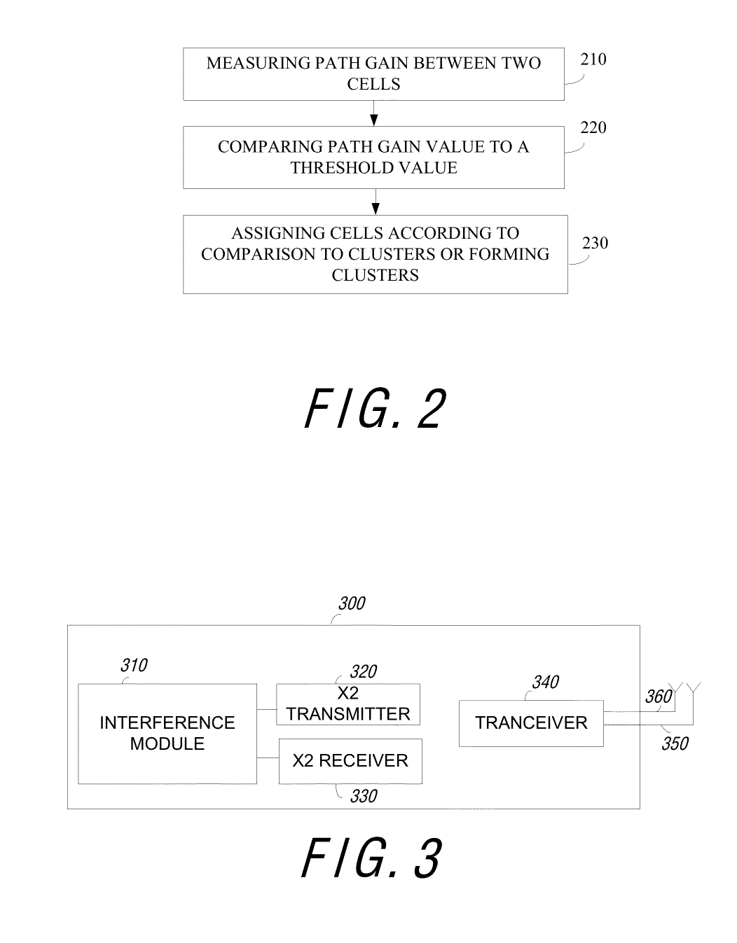

Reference is made to FIG. 2, which schematically illustrates a flow chart of a method of cluster management, in accordance with some demonstrative embodiments. Although some embodiments are not limited to this example, the method of cluster management may include combining two or more cells, for example pico cells, into one or more clusters, e.g., isolated cluster. A cluster may include a cell or a group of cells characterized according to a predetermined coupling parameter between a first cell to cell link to a second cell to cell link, if desired.

According this example, a base station, for example eNodeB, may measure a path gain of a link between two cells to provide a path gain value (text block 210). The base station may compare the path gain value to a predetermined threshold value (text block 220). The base station may assign the cell or the group of cells into the cluster, e.g., according to the comparison (text block 230).

According to one demonstrative embodiment, the assignment of cell may be done in a centralized fashion, for example, by an Operations, Administration, and Maintenance (OAM) functionalities. For example, the OAM functionalities may collect path gain measurements from plurality of cells, e.g., by a central base station; may compare the path gain measurements to a predetermined threshold value; and may assign the cell to the cluster, e.g., based on the comparison.

According to another demonstrative embodiment, the base station may form clusters in a distributed fashion, e.g., via an X2 application protocol (X2AP). The base station e.g., eNodeB, may exchange path gain measurements of a cell with other base stations, e.g., by X2AP messages, although some embodiments are not limited to this example.

Reference is made to FIG. 3, which schematically illustrates a base station 300, in accordance with some demonstrative embodiments. For example, base station 300 may perform the functionality of base station 122 (FIG. 1) and/or base station 142 (FIG. 1) and/or base station 172 (FIG. 1) and/or base station 182 (FIG. 1).

In some demonstrative embodiments, base station 300 may include an interference manager module 310, an X2 transmitter 320, an X2 receiver 330, a radio transceiver 340 and antennas 350 and 360. For example, base station 300 may be implemented as part of an LTE cellular system and may include an eNodeB, a Home eNodeB, a femto cell, a pico cell, a cellular node, or the like. It should be understood that only some of the base station functionalities and block are present. In Practice, an LTE base station may further include a communication processor (not shown) to control the downlink-uplink traffic. For example the communication processor may include interference manager module 310 and other software and/or hardware modules, if desired.

In some demonstrative embodiments, antennas 350 and/or 360 may include any type of antennas suitable for transmitting and/or receiving wireless communication signals, blocks, frames, transmission streams, packets, messages and/or data. For example, antennas 350 and/or 360 may include any suitable configuration, structure and/or arrangement of one or more antenna elements, components, units, assemblies and/or arrays. For example, antennas 350 and/or 360 may include a phased array antenna, a dipole antenna, a single element antenna, a set of switched beam antennas, and/or the like.

Although some embodiments are not limited to this example, base station 300 may transmit a message including a channel quality parameter and a Time-Division-Duplex (TDD) configuration update to at least one other base station, e.g., base station 122 of cellular cell 120 (FIG. 1). Interference manager module 310 may decide, for example, if cellular cell 120 (FIG. 1) is to be operated in cluster 110 (FIG. 1), for example, based on the channel quality parameter value. Interference manager module 310 may, for example, coordinate an adjustment of uplink-downlink configuration according to a traffic condition.

According to this exemplary embodiment, the message may include an X2 Application Protocol (X2-AP) message, e.g., according to Table 1 and/or Table 2 and/or table 3. For example, Table 1 demonstrates a LOAD INFORMATION X2AP message and the channel quality parameter includes a path gain indication information element (IE) to indicate a path gain of an inter-cell base station to base station link.

In some demonstrative embodiments, X2 Receiver 330 may receive the path gain of the inter-cell base station to base station link. Interference manager module 310 may analyze a downlink-uplink interference from a plurality of neighboring cellular base stations, e.g., base stations 142, 152, 172 and/or 182 (FIG. 1), according to the path gain the inter-cell base station to base station link, and a transmit power of base station 300; and may decide which base station of the plurality of neighboring base station e.g., base stations 142, 152, 172 and/or 182 (FIG. 1), is to be included in an isolated cluster based, for example, on a comparison result of the path gain with a predetermined threshold.

In one demonstrative embodiment, X2 transmitter 320 may transmit to a peer base station, e.g., base stations 142, 152, 172 and/or 182 (FIG. 1), for example via internet protocol, a LOAD INFORMATION X2AP message which includes an average interference over thermal noise (IoT) indication IE and an average interference over thermal noise (IoT) information IE. The IoT information IE may include target cell identification (ID) and IoT indication subfields, e.g., according to Table 2-Average IoT message, if desired.

According to another embodiment, transmitter 320 may transmit to a peer base station, e.g., base stations 142, 152, 172 and/or 182 (FIG. 1), a LOAD INFORMATION X2AP message which includes a down link (DL) transmit (Tx) power information IE. The DL Tx power information IE may include a list, e.g., of one to ten entries, a subframe index subframe and a Tx power subframe, e.g., according to Table 3-DL Transmit Power Control Map message. The LOAD INFORMATION X2AP message may be used to provide power levels of a flexible subframe that dynamically change their transmission direction from downlink to uplink, although some embodiments are not limited in this respect.

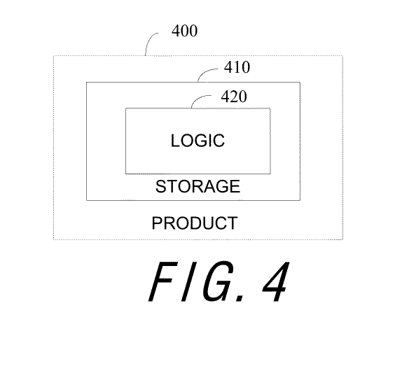

Reference is made to FIG. 4, which schematically illustrates a product of manufacture 400, in accordance with some demonstrative embodiments. Product 400 may include a non-transitory machine-readable storage medium 410 to store logic 420. The phrase “non-transitory machine-readable medium” is directed to include all computer-readable media, with the sole exception being a transitory propagating signal.

In some demonstrative embodiments, product 400 and/or machine-readable storage medium 410 may include one or more types of computer-readable storage media capable of storing data, including volatile memory, non-volatile memory, removable or non-removable memory, erasable or non-erasable memory, writeable or re-writeable memory, and the like. For example, machine-readable storage medium 410 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 420 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 420 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

In some demonstrative embodiments, logic 420 may be used, for example, to perform at least part of the functionality of a BS, e.g., BS 122, 142, 152, 172 and/or 182 (FIG. 1), and/or one or more elements of base station 300 (FIG. 3), and/or to perform one or more operations of the method of FIG. 2.

In some demonstrative embodiments, logic 420 may include instructions that, when executed by a machine e.g., a base station, may result in assigning two or more cells, e.g., cells 120, 140, 150, 160 and/or 180 (FIG. 1), into two or more clusters, e.g., isolated clusters 110, 130 and/or 160. The cluster may include a cell, e.g., isolated cluster 110 and cell 120, or a group of cells, e.g., cluster 130 and cells 140 and 150 (FIG. 1), characterized, for example, according to coupling strength between two or more cell to cell links, if desired

According to this example, the assigning may include measuring a path gain of a link between two cells to provide a path gain value; comparing the path gain value to a predetermined threshold value; and deciding according to the comparison whether to group the cell into the cluster.

In one demonstrative embodiment, product 400 may perform the functionality of, e.g., a base station, which may assign the cell in a centralized fashion by Operations, Administration, and Maintenance (OAM) functionalities, wherein the OAM functionalities collect path gain measurements from plurality of cells by a central base station, compare the path gain measurements to a predetermined threshold value and assign the cell to the cluster based on the comparison.

In another embodiment, product 400 may perform the functionality of, for example, interference module manager 310 (FIG. 3), which may form clusters, e.g., clusters 110, 130 and/or 160 (FIG. 1), in a distributed fashion by a base station via X2 application protocol (X2AP). The base station, e.g., base station 122 (FIG. 1), may exchange a path gain measurements of a cell by X2AP messages, if desired.

According to some demonstrative embodiments, the cell may include a pico cell and the link between the cells may include a link between two pico cells, if desired. In other embodiments, the base station may include eNodeB, although some embodiments are not limited to the above described examples.

### EXAMPLES

The following examples pertain to further embodiments.

Example 1 includes a base station comprising a transmitter to transmit a message over X2 application protocol (X2AP) including a channel quality parameter value and a Time-Division-Duplex (TDD) configuration update to at least one other base station of a cellular cell; and an interference manager to decide if the cellular cell is to be operated in a cluster based on the channel quality parameter value, and to coordinate an adjustment of an uplink-downlink configuration according to a traffic condition.

Example 2 includes the subject matter of Example 1 and optionally, wherein the message comprises an X2 Application Protocol (X2-AP) message.

Example 3 includes the subject matter of Example 2 and optionally, wherein the message comprises a LOAD INFORMATION X2AP message and the channel quality parameter includes a path gain indication information element (IE) to indicate a path gain of an inter-cell base station to base station link.

Example 4 includes the subject matter of Example 3, and optionally comprising a receiver to receive the X2AP message which includes the path gain of the inter-cell base station to base station link, wherein the interference manager is to analyze a downlink-uplink interference from a plurality of neighboring cellular base stations according to the path gain of the inter-cell base station to base station link and a transmit power of the base station, and to decide which base station of the plurality of neighboring base stations is to be included in an isolated cluster based on a comparison of the path gain with a threshold.

Example 5 includes the subject matter of Example 2 and optionally, wherein the transmitter is to transmit to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

Example 6 includes the subject matter of Example 2 and optionally, wherein the transmitter is to transmit to a peer base station a LOAD INFORMATION X2AP message which includes a down link (DL) transmit (Tx) power information IE, wherein the DL Tx power information IE includes a list of one to ten entries, a subframe index subframe and a Tx power subframe.

Example 7 includes the subject matter of Example 6 and optionally, wherein the LOAD INFORMATION X2AP message is used to provide power levels of flexible subframes that dynamically change their transmission direction from downlink to uplink.

Example 8 includes the subject matter of any one of Examples 1-7 and optionally, wherein the cluster comprises one or more cellular cells.

Example 9 includes the subject matter of any one of Examples 1-8 and optionally, wherein the base station comprises an evolved node B (eNodeB).

Example 10 includes the subject matter of any one of Examples 1-9 and optionally, wherein the cellular cell comprises a Pico-cell.

Example 11 includes a cellular communication network comprising at least one cellular cell including a base station to communicate with a user equipment (UE) device, wherein the base station is to transmit an X2 Application Protocol (X2AP) message including a channel quality parameter and a Time-Division-Duplex (TDD) configuration update to update at least one other cellular cell, and wherein the channel quality parameter is to allow deciding which one of the at least one other cellular cell is to be included in a cluster.

Example 12 includes the subject matter of Example 11 and optionally, wherein the channel quality parameter includes a path gain indication information element (IE) to indicate a path gain of an inter-cell base station to base station link.

Example 13 includes the subject matter of Example 12 and optionally, wherein the base station is to analyze a downlink-uplink interference from a plurality of neighboring cellular base stations according to the path gain of the inter-cell base station to base station link, and a transmit power of the cellular node, and to decide which base station of the plurality of neighboring base stations to be included in an isolated cluster based on a comparison between the path gain and a threshold.

Example 14 includes the subject matter of Example 11 and optionally, wherein the base station is to transmit to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

Example 15 includes the subject matter of Example 11 and optionally, wherein the base station is to transmit to a peer base station a LOAD INFORMATION X2AP message which includes a down link (DL) transmit (Tx) power information IE, wherein the DL Tx power information IE includes a list of one to ten entries, a subframe index subframe and a Tx power subframe.

Example 16 includes the subject matter of Example 15 and optionally, wherein the LOAD INFORMATION X2AP message is to provide power levels of flexible subframes that dynamically change their transmission direction from downlink to uplink.

Example 17 includes the subject matter of any one of Examples 11-16 and optionally, wherein the cluster comprises one or more cellular cells.

Example 18 includes the subject matter of any one of Examples 11-17 and optionally, wherein the base station comprises an evolved node B (eNodeB).

Example 19 includes the subject matter of any one of Examples 11-18 and optionally, wherein the at least one cellular cell comprises a Pico-cell.

Example 20 includes a communication method comprising transmitting by a base station a message over X2 application protocol (X2AP) including a channel quality parameter value and a Time-Division-Duplex (TDD) configuration update to at least one other base station of a cellular cell; deciding if the cellular cell is to be operated in a cluster based on the channel quality parameter value; and coordinating an adjustment of an uplink-downlink configuration according to a traffic condition.

Example 21 includes the subject matter of Example 20 and optionally, wherein the message comprises an X2 Application Protocol (X2-AP) message.

Example 22 includes the subject matter of Example 21 and optionally, wherein the message comprises a LOAD INFORMATION X2AP message and the channel quality parameter includes a path gain indication information element (IE) to indicate a path gain of an inter-cell base station to base station link.

Example 23 includes the subject matter of Example 22 and optionally comprising receiving the X2AP message which includes the path gain of the inter-cell base station to base station link; analyzing a downlink-uplink interference from a plurality of neighboring cellular base stations according to the path gain of the inter-cell base station to base station link and a transmit power of the base station; and deciding which base station of the plurality of neighboring base stations is to be included in an isolated cluster based on a comparison of the path gain with a threshold.

Example 24 includes the subject matter of Example 21 and optionally comprising transmitting to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

Example 25 includes the subject matter of Example 21 and optionally comprising transmitting to a peer base station a LOAD INFORMATION X2AP message which includes a down link (DL) transmit (Tx) power information IE, wherein the DL Tx power information IE includes a list of one to ten entries, a subframe index subframe and a Tx power subframe.

Example 26 includes the subject matter of Example 25 and optionally, wherein the LOAD INFORMATION X2AP message is used to provide power levels of flexible subframes that dynamically change their transmission direction from downlink to uplink.

Example 27 includes the subject matter of any one of Examples 20-26 and optionally, wherein the cluster comprises one or more cellular cells.

Example 28 includes the subject matter of any one of Examples 20-27 and optionally, wherein the base station comprises an evolved node B (eNodeB).

Example 29 includes the subject matter of any one of Examples 20-28 and optionally, wherein the cellular cell comprises a Pico-cell.

Example 30 includes product including a non-transitory storage medium having stored thereon instructions that, when executed by a machine, result in transmitting by a base station a message over X2 application protocol (X2AP) including a channel quality parameter value and a Time-Division-Duplex (TDD) configuration update to at least one other base station of a cellular cell; deciding if the cellular cell is to be operated in a cluster based on the channel quality parameter value; and coordinating an adjustment of an uplink-downlink configuration according to a traffic condition.

Example 31 includes the subject matter of Example 30 and optionally, wherein the message comprises an X2 Application Protocol (X2-AP) message.

Example 32 includes the subject matter of Example 31 and optionally, wherein the message comprises a LOAD INFORMATION X2AP message and the channel quality parameter includes a path gain indication information element (IE) to indicate a path gain of an inter-cell base station to base station link.

Example 33 includes the subject matter of Example 32 and optionally, wherein the instructions result in receiving the X2AP message which includes the path gain of the inter-cell base station to base station link; analyzing a downlink-uplink interference from a plurality of neighboring cellular base stations according to the path gain of the inter-cell base station to base station link and a transmit power of the base station; and deciding which base station of the plurality of neighboring base stations is to be included in an isolated cluster based on a comparison of the path gain with a threshold.

Example 34 includes the subject matter of Example 31 and optionally, wherein the instructions result in transmitting to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

Example 35 includes the subject matter of Example 31 and optionally, wherein the instructions result in transmitting to a peer base station a LOAD INFORMATION X2AP message which includes a down link (DL) transmit (Tx) power information IE, wherein the DL Tx power information IE includes a list of one to ten entries, a subframe index subframe and a Tx power subframe.

Example 36 includes the subject matter of Example 35 and optionally, wherein the LOAD INFORMATION X2AP message is used to provide power levels of flexible subframes that dynamically change their transmission direction from downlink to uplink.

Example 37 includes the subject matter of any one of Examples 30-36 and optionally, wherein the cluster comprises one or more cellular cells.

Example 38 includes the subject matter of any one of Examples 30-37 and optionally, wherein the base station comprises an evolved node B (eNodeB).

Example 39 includes the subject matter of any one of Examples 30-38 and optionally, wherein the cellular cell comprises a Pico-cell.

Example 40 includes a communication apparatus comprising means for transmitting by a base station a message over X2 application protocol (X2AP) including a channel quality parameter value and a Time-Division-Duplex (TDD) configuration update to at least one other base station of a cellular cell; means for deciding if the cellular cell is to be operated in a cluster based on the channel quality parameter value; and means for coordinating an adjustment of an uplink-downlink configuration according to a traffic condition.

Example 41 includes the subject matter of Example 40 and optionally, wherein the message comprises an X2 Application Protocol (X2-AP) message.

Example 42 includes the subject matter of Example 41 and optionally, wherein the message comprises a LOAD INFORMATION X2AP message and the channel quality parameter includes a path gain indication information element (IE) to indicate a path gain of an inter-cell base station to base station link.

Example 43 includes the subject matter of Example 42 and optionally comprising means for receiving the X2AP message which includes the path gain of the inter-cell base station to base station link; means for analyzing a downlink-uplink interference from a plurality of neighboring cellular base stations according to the path gain of the inter-cell base station to base station link and a transmit power of the base station; and means for deciding which base station of the plurality of neighboring base stations is to be included in an isolated cluster based on a comparison of the path gain with a threshold.

Example 44 includes the subject matter of Example 41 and optionally comprising means for transmitting to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

Example 45 includes the subject matter of Example 41 and optionally comprising means for transmitting to a peer base station a LOAD INFORMATION X2AP message which includes a down link (DL) transmit (Tx) power information IE, wherein the DL Tx power information IE includes a list of one to ten entries, a subframe index subframe and a Tx power subframe.

Example 46 includes the subject matter of Example 45 and optionally, wherein the LOAD INFORMATION X2AP message is used to provide power levels of flexible subframes that dynamically change their transmission direction from downlink to uplink.

Example 47 includes the subject matter of any one of Examples 40-46 and optionally, wherein the cluster comprises one or more cellular cells.

Example 48 includes the subject matter of any one of Examples 40-47 and optionally, wherein the base station comprises an evolved node B (eNodeB).

Example 49 includes the subject matter of any one of Examples 40-48 and optionally, wherein the cellular cell comprises a Pico-cell.

Example 50 includes a base station comprising an interference manager to assign two or more cells into one or more clusters, wherein a cluster includes either a cell or a group of cells characterized according to a coupling strength between two or more cells.

Example 51 includes the subject matter of Example 50 and optionally, wherein the interference manager is to measure a path gain of a link between two cells to provide a path gain value; compare the path gain value to a threshold value; and decide according to the comparison whether to group the cell into the cluster.

Example 52 includes the subject matter of Example 51 and optionally, wherein the cell comprises a pico cell and the link includes a link between two pico cells.

Example 53 includes the subject matter of Example 50 and optionally, wherein the interference manager is to assign the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

Example 54 includes the subject matter of Example 50 and optionally, wherein the interference manager is to form clusters in a distributed fashion by a base station via X2 application protocol (X2AP) by exchanging a path gain measurements of a cell by X2AP messages.

Example 55 includes the subject matter of any one of Examples 50-54 and optionally, wherein the cell comprises a pico cell and the link includes a link between two pico cells.

Example 56 includes the subject matter of any one of Examples 50-55 and optionally, wherein the cell comprises an evolved node B (eNodeB).

Example 57 includes a cellular communication network comprising a base station including a transmitter, and an interference manager to assign two or more cells into one or more clusters, wherein a cluster includes either a cell or a group of cells characterized according to a coupling strength between two or more cells.

Example 58 includes the subject matter of Example 57 and optionally, wherein the interference manager is to measure a path gain of a link between two cells to provide a path gain value; compare the path gain value to a threshold value; and decide according to the comparison whether to group the cell into the cluster.

Example 59 includes the subject matter of Example 58 and optionally, wherein the cell comprises a pico cell and the link includes a link between two pico cells.

Example 60 includes the subject matter of Example 57 and optionally, wherein the interference manager is to assign the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

Example 61 includes the subject matter of Example 57 and optionally, wherein the interference manager is to form clusters in a distributed fashion by a base station via X2 application protocol (X2AP) by exchanging a path gain measurements of a cell by X2AP messages.

Example 62 includes the subject matter of any one of Examples 57-61 and optionally, wherein the cell comprises a pico cell and the link includes a link between two pico cells.

Example 63 includes the subject matter of any one of Examples 57-62 and optionally, wherein the cell comprises an evolved node B (eNodeB).

Example 64 includes a method of cluster management comprising assigning two or more cells into one or more clusters, wherein a cluster includes either a cell or a group of cells characterized according to a coupling strength between two or more cells.

Example 65 includes the subject matter of Example 64 and optionally, wherein assigning comprises measuring a path gain of a link between two cells to provide a path gain value; comparing the path gain value to a threshold value; and

deciding according to the comparison whether to group the cell into the cluster.

Example 66 includes the subject matter of Example 65 and optionally, wherein the cell comprises a pico cell and the link includes a link between two pico cells.

Example 67 includes the subject matter of Example 64 and optionally comprising assigning the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

Example 68 includes the subject matter of Example 64 and optionally comprising forming clusters in a distributed fashion by a base station via X2 application protocol (X2AP) by exchanging a path gain measurements of a cell by X2AP messages.

Example 69 includes the subject matter of any one of Examples 64-68 and optionally, wherein the cell comprises a pico cell and the link includes a link between two pico cells.

Example 70 includes the subject matter of any one of Examples 64-69 and optionally, wherein the cell comprises an evolved node B (eNodeB).

Example 71 includes A product including a non-transitory storage medium having stored thereon instructions that, when executed by a machine, result in assigning two or more cells into one or more clusters, wherein a cluster includes either a cell or a group of cells characterized according to a coupling strength between two or more cells.

Example 72 includes the subject matter of Example 71 and optionally, wherein assigning comprises measuring a path gain of a link between two cells to provide a path gain value; comparing the path gain value to a threshold value; and

deciding according to the comparison whether to group the cell into the cluster.

Example 73 includes the subject matter of Example 71 and optionally, wherein the cell comprises a pico cell and the link includes a link between two pico cells.

Example 74 includes the subject matter of Example 71 and optionally, wherein the instructions result in assigning the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

Example 75 includes the subject matter of Example 71 and optionally, wherein the instructions result in forming clusters in a distributed fashion by a base station via X2 application protocol (X2AP) by exchanging a path gain measurements of a cell by X2AP messages.

Example 76 includes the subject matter of any one of Examples 71-75 and optionally, wherein the cell comprises a pico cell and the link includes a link between two pico cells.

Example 77 includes the subject matter of any one of Examples 71-76 and optionally, wherein the cell comprises an evolved node B (eNodeB).

Example 78 includes an apparatus of cluster management comprising means for assigning two or more cells into one or more clusters, wherein a cluster includes either a cell or a group of cells characterized according to a coupling strength between two or more cells.

Example 79 includes the subject matter of Example 78 and optionally, wherein assigning comprises measuring a path gain of a link between two cells to provide a path gain value; comparing the path gain value to a threshold value; and

deciding according to the comparison whether to group the cell into the cluster.

Example 80 includes the subject matter of Example 79 and optionally, wherein the cell comprises a pico cell and the link includes a link between two pico cells.

Example 81 includes the subject matter of Example 78 and optionally comprising means for assigning the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

Example 82 includes the subject matter of Example 78 and optionally comprising means for forming clusters in a distributed fashion by a base station via X2 application protocol (X2AP) by exchanging a path gain measurements of a cell by X2AP messages.

Example 83 includes the subject matter of any one of Examples 78-82 and optionally, wherein the cell comprises a pico cell and the link includes a link between two pico cells.

Example 84 includes the subject matter of any one of Examples 78-83 and optionally, wherein the cell comprises an evolved node B (eNodeB).

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A base station comprising:
a transmitter to transmit a message over X2 application protocol (X2AP) including a channel quality parameter value and a Time-Division-Duplex (TDD) configuration update to at least one other base station of a cellular cell; and
an interference manager to decide if the cellular cell is to be operated in a cluster based on the channel quality parameter value, and to coordinate an adjustment of an uplink-downlink configuration according to a traffic condition.

2. The base station of claim 1, wherein said message comprises an X2 Application Protocol (X2-AP) message.

3. The base station of claim 2, wherein said message comprises a LOAD INFORMATION X2AP message and the channel quality parameter includes a path gain indication information element (IE) to indicate a path gain of an inter-cell base station to base station link.

4. The base station of claim 3, comprising:
a receiver to receive the X2AP message which includes the path gain of the inter-cell base station to base station link,
wherein the interference manager is to analyze a downlink-uplink interference from a plurality of neighboring cellular base stations according to the path gain of the inter-cell base station to base station link and a transmit power of the base station, and to decide which base station of the plurality of neighboring base stations is to be included in an isolated cluster based on a comparison of the path gain with a threshold.

5. The base station of claim 2, wherein the transmitter is to transmit to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

6. The base station of claim 2, wherein the transmitter is to transmit to a peer base station a LOAD INFORMATION X2AP message which includes a down link (DL) transmit (Tx) power information IE, wherein the DL Tx power information IE includes a list of one to ten entries, a subframe index subframe and a Tx power subframe.

7. The base station of claim 6, wherein the LOAD INFORMATION X2AP message is used to provide power levels of flexible subframes that dynamically change their transmission direction from downlink to uplink.

8. A method of cluster management comprising:
assigning two or more cells into one or more clusters, wherein a cluster includes either a cell or a group of cells characterized according to a coupling strength between two or more cells.

9. The method of claim 8, wherein assigning comprises:
measuring a path gain of a link between two cells to provide a path gain value;
comparing the path gain value to a threshold value; and
deciding according to the comparison whether to group the cell into the cluster.

10. The method of claim 8 comprising:
assigning the cell in a centralized fashion by Operations, Administration, and Maintenance (OAM) functionalities, wherein the OAM functionalities include collecting path gain measurements from a plurality of cells by a central base station, comparing the path gain measurements to a threshold value and assigning the cell to the cluster based on the comparison.

11. The method of claim 8 comprising:
forming clusters in a distributed fashion by a base station via X2 application protocol (X2AP) by exchanging a path gain measurements of a cell by X2AP messages.

12. The method of claim 8, wherein the cell comprises a pico cell and the link includes a link between two pico cells.

13. The method of claim 8 wherein the cell comprises an evolved node B (eNodeB).

14. A cellular communication network comprising:
at least one cellular cell including a base station to communicate with a user equipment (UE) device, wherein the base station is to transmit an X2 Application Protocol (X2AP) message including a channel quality parameter and a Time-Division-Duplex (TDD) configuration update to update at least one other cellular cell, and wherein the channel quality parameter is to allow deciding which one of the at least one other cellular cell is to be included in a cluster.

15. The cellular communication network of claim 14, wherein the channel quality parameter includes a path gain indication information element (IE) to indicate a path gain of an inter-cell base station to base station link.

16. The cellular communication network of claim 15, wherein the base station is to analyze a downlink-uplink interference from a plurality of neighboring cellular base stations according to the path gain of the inter-cell base station to base station link, and a transmit power of the cellular node, and to decide which base station of the plurality of neighboring base stations to be included in an isolated cluster based on a comparison between the path gain and a threshold.

17. The cellular communication network of claim 14, wherein the base station is to transmit to a peer base station a LOAD INFORMATION X2AP message which includes an average interference over thermal noise (IoT) indication IE and an average interference over thermal noise (IoT) information IE, the IoT information IE includes target cell identification (ID) and IoT indication subfields.

18. The cellular communication network of claim 14, wherein the base station is to transmit to a peer base station a LOAD INFORMATION X2AP message which includes a down link (DL) transmit (Tx) power information IE, wherein the DL Tx power information IE includes a list of one to ten entries, a subframe index subframe and a Tx power subframe.

19. The cellular communication network of claim 18, wherein the LOAD INFORMATION X2AP message is to provide power levels of flexible subframes that dynamically change their transmission direction from downlink to uplink.

20. The cellular communication network of claim 14, wherein the cluster comprises one or more cellular cells.

21. The cellular communication network of claim 14, wherein the base station an evolved node B (eNodeB)

22. The cellular communication network of claim 14, wherein the at least one cellular cell comprises a Pico-cell.

23. A product including a non-transitory storage medium having stored thereon instructions that, when executed by a machine, result in:
assigning two or more cells into one or more clusters, wherein a cluster includes a cell or a group of cells characterized according to coupling strength between two or more cells.

24. The product of claim 23, wherein assigning comprising:
measuring a path gain of a link between two cells to provide a path gain value;
comparing the path gain value to a threshold value; and
deciding according to the comparison whether to group the cell into the cluster.

25. The product of claim 24, wherein the cell comprises a pico cell and the link includes a link between two pico cells.

26. The product of claim 23 comprising:
assigning the cell in a centralized fashion by Operations, Administration, and Maintenance (OAM) functionalities, wherein the OAM functionalities include collecting path gain measurements from plurality of cells by a central base station, comparing the path gain measurements to a threshold value, and assigning the cell to the cluster based on the comparison.

27. The product of claim 23 comprising:
forming clusters in a distributed fashion by a base station via X2 application protocol (X2AP) by exchanging a path gain measurements of a cell by X2AP messages.

28. The product of claim 23, wherein the base station comprise an evolved node B (eNode B).
